(19) United States
(12) Patent Application Publication
(10) Pub. No.: US 2013/0279187 A1
(43) Pub. Date: Oct. 24, 2013

(54) LED REAR WARNING LAMP

(71) Applicant: Wen Chang WANG, Anding (TW)

(72) Inventor: Wen Chang WANG, Anding (TW)

(21) Appl. No.: 13/454,097

(22) Filed: Apr. 24, 2012

(51) Int. Cl. B60Q 1/52

(52) U.S. Cl. 362/487

(57) ABSTRACT

An LED rear warning lamp includes a deflector plate assembled at a rear side of an automobile and formed with an accommodating chamber in the interior. A lamp set in the accommodating chamber of the deflector plate is composed of a base, a transparent inner cap, an LED circuit board, a cover plate, a shade and a transparent lamp casing. The LED circuit board is closely attached to the cover plate and then reversely fixed with the transparent inner cap that has its inner lower side protuberantly provided with irregularly refractive patterns. Thus, when reverse light of LEDs is projected upon the refractive patterns of the transparent inner cap, the refractive patterns will refract the light to the transparent lamp casing to send out even and soft light for warning.

### BACKGROUND OF THE INVENTION

1. Field of the Invention

This invention relates to an LED rear warning lamp, particularly to one provided with a deflector plate assembled at a rear side of an automobile and having its interior formed with an accommodating chamber. A lamp to be received in the accommodating chamber of the deflector plate is composed of a base, a transparent inner cap, an LED circuit board, a cover plate, a shade and a transparent lamp casing. The LED circuit board is firstly attached to the cover plate and then reversely fixed with the transparent inner cap that has its lower side protuberantly disposed with irregularly refractive patterns. Thus, when the LEDs installed on the LED circuit board are started emitting, the reverse light of the LEDs will be projected upon the refractive patterns of the transparent inner cap and simultaneously the refractive patterns will refract the light to the transparent lamp casing to send out soft and well-distributed light for warning.

2. Description of the Prior Art

Generally, light emitted by most conventional LED rear warning lamps is directly projected to a lamp casing so the warning light of rectilinear irradiation is strong enough to irritate the eyes of the driver of the automobile coming from behind.

### SUMMARY OF THE INVENTION

The objective of this invention is to offer an LED rear warning lamp that is able to send out even and soft light for warning.

The LED rear warning lamp in the present invention includes a deflector plate assembled at a rear side of an automobile and formed with an accommodating chamber in the interior. A lamp received in the accommodating chamber of the deflector plate is composed of a base, a transparent inner cap, an LED circuit board, a cover plate, a shade and a transparent lamp casing. The LED circuit board is firstly attached to the cover plate and then reversely fixed with the transparent inner cap, which has its inner lower side protuberantly disposed with irregularly refractive patterns.

### BRIEF DESCRIPTION OF DRAWINGS

This invention will be better understood by referring to the accompanying drawings, wherein:

FIG. 1 is an exploded perspective view of an LED rear warning light in the present invention;

FIG. 2 is a perspective view of the LED rear warning light in the present invention;

FIG. 3 is a cross-sectional view of the LED rear warning light in the present invention;

FIG. 4 is a side cross-sectional view of the LED rear warning light in a using condition in the present invention; and

FIG. 5 is a schematic view of the LED rear warning light in a using condition in the present invention.

### DETAILED DESCRIPTION OF THE PREFERRED EMBODIMENT

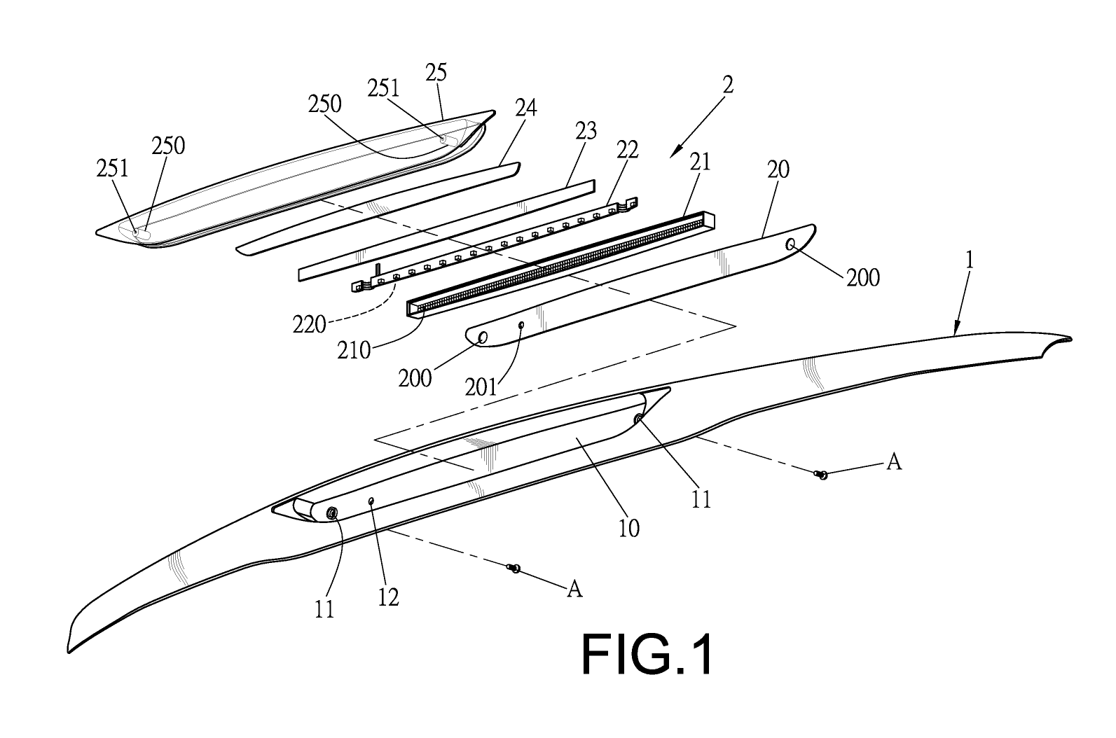

A preferred embodiment of an LED rear warning lamp in the present invention, as shown in FIG. 1, includes a deflector plate 1 assembled at a rear side of an automobile. The deflector plate 1 is provided in the interior with an accommodating chamber 10 having two sides respectively disposed with a combining hole 11 and is bored with an insert hole 12 at a proper location. A lamp 2 received in the accommodating chamber 10 of the deflector plate 1 is composed of a base 20, a transparent inner cap 21, an LED circuit board 22, a cover plate 23, a shade 24 and a transparent lamp casing 25. The base 20 has two sides respectively formed with a combining hole 200 and is bored with an insert hole at a proper location. The transparent inner cap 21 has its inner lower side protuberantly provided with irregularly refractive patterns 210. The LED circuit board 22 is installed thereon with a plurality of LEDs 220, and the transparent lamp casing 25 has two opposite sides respectively fixed thereon with a stud 250 with a central threaded hole 251.

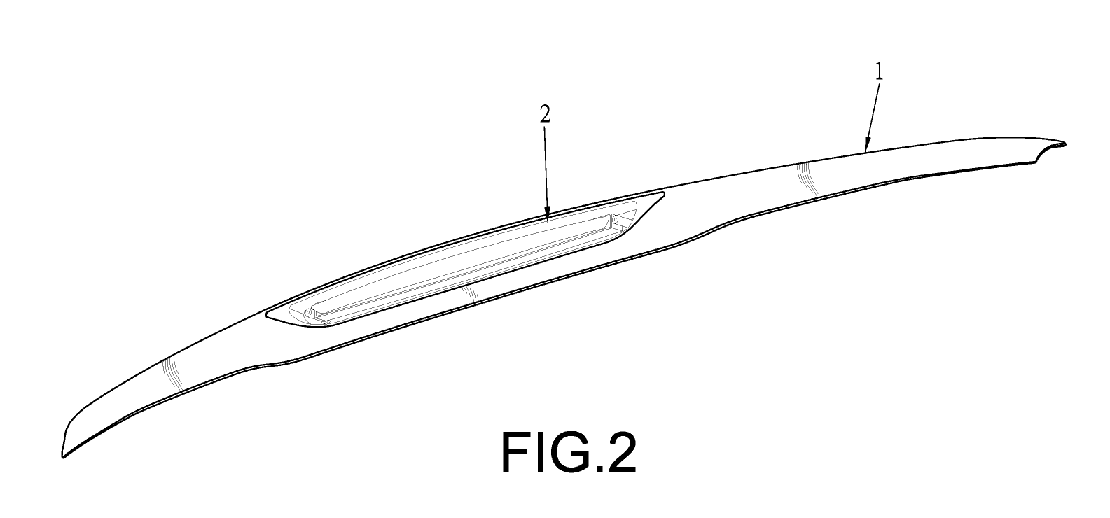

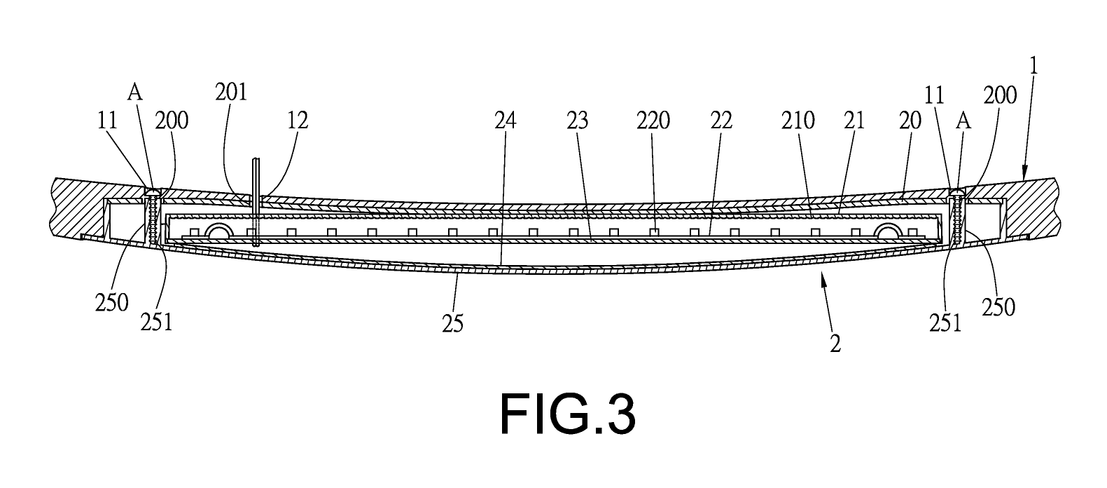

In assembling, referring to FIGS. 1-3, firstly, have the LED circuit board 22 closely attached to the cover plate 23 and then reversely secured with the transparent inner cap 21. Next, have the transparent inner shade 21 stuck to the base 20 and have the shade 24 covered on both the LED circuit board 22 and the cover plate 23 and then set the shade 24 inside the transparent lamp casing 25, letting the threaded holes 251 of the transparent lamp casing 25 respectively aligned to the combining holes 200 of the base 20 and thus finishing assembly of the lamp 2. Subsequently, set the lamp 2 in the accommodating chamber 10 of the deflector plate 2, letting the two combining holes 200 of the base 20 respectively aligned to the two combining holes 11 of the deflector plate 1 and the insert hole 201 of the base 20 corresponding with the insert hole 12 of the deflector plate 1. Lastly, have screws (A) inserted through the combining holes 11 of the deflector plate 1 and through the combining holes 200 of the base 20 and then threadably fixed in the threaded holes 251 of the transparent lamp casing 25 to finish assembly of the LED rear warning lamp.

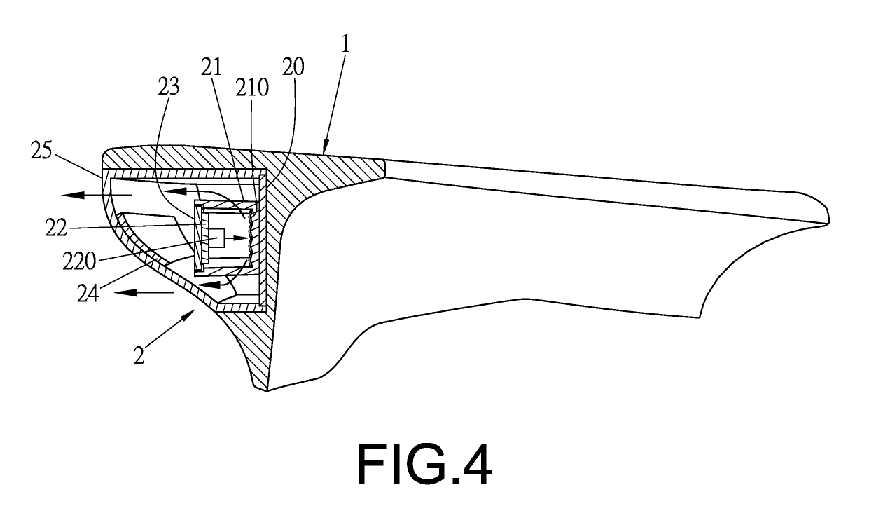

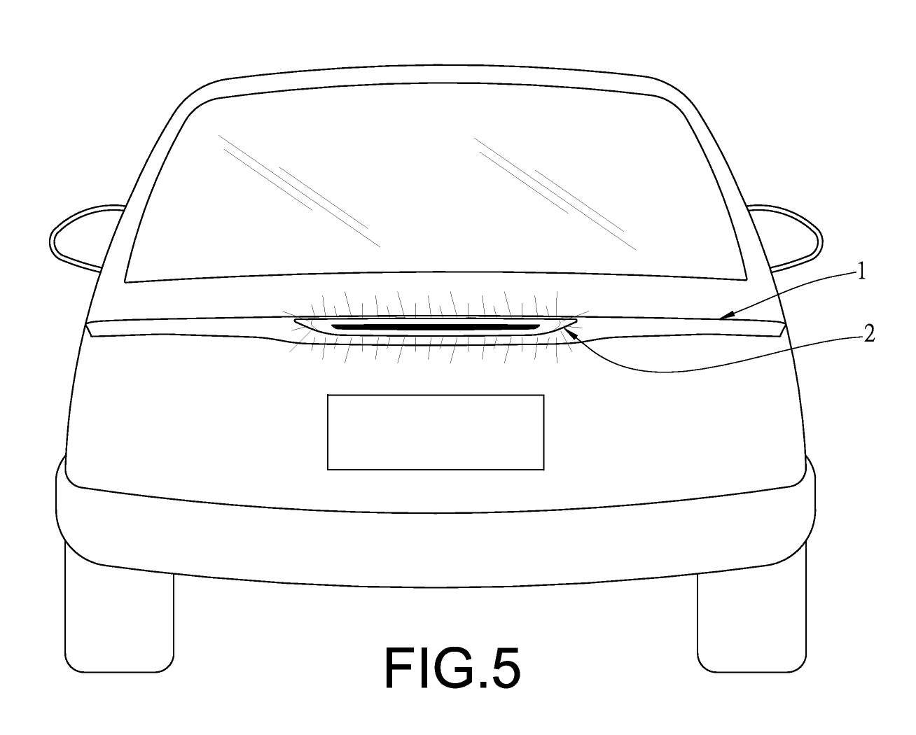

In using, referring to FIGS. 4 and 5, when the LEDs 220 are started emitting reversely, the reverse light of the LEDs 220 will be projected upon the refractive patterns 210 of the transparent inner cap 21 and simultaneously, the refractive patterns 210 will refract the light to the transparent lamp casing 25 to send out even and soft light for warning.

While the preferred embodiment of the invention has been described above, it will be recognized and understood that various modifications may be made therein and the appended claims are intended to cover all such modifications that may fall within the spirit and scope of the invention.

What is claimed is:

1. An LED rear warning lamp comprising:
a deflector plate assembled at a rear side of an automobile, said deflector plate formed with an accommodating chamber in an interior; and a lamp set in said accommodating chamber of said deflector plate, said lamp composed of a base, a transparent inner cap, an LED circuit board, a cover plate, a shade and a transparent lamp casing, said LED circuit board closely attached to said cover plate and then reversely fixed with said transparent inner cap, said transparent inner cap protuberantly provided with irregularly refractive patterns at the inner lower side.

2. The LED rear warning lamp as claimed in claim 1, wherein said accommodating chamber of said deflector plate has two opposite sides respectively formed with a combining hole, and said accommodating chamber is further bored with an insert hole at a proper location.

3. The LED rear warning lamp as claimed in claim 1, wherein said base has two sides respectively provided with a combining hole, and an insert hole at a proper location.

4. The LED rear warning lamp as claimed in claim 1, wherein said transparent lamp casing has two sides respectively secured thereon with a stud, said stud formed therein with a threaded hole.
